(19) United States
(12) Patent Application Publication
(10) Pub. No.: US 2026/0211157 A1
(43) Pub. Date: Jul. 23, 2026

(54) IRIDESCENT OPTICAL FILM

(71) Applicant: BD (Xiamen) Technology Co., Ltd., Fujian (CN)

(72) Inventors: Po Yen CHOU, Fujian (CN); Jingguo ZHUANG, Fujian (CN); Jiahu WEI, Fujian (CN)

(21) Appl. No.: 19/452,862

(22) Filed: Jan. 19, 2026

(30) Foreign Application Priority Data
Jan. 21, 2025 (CN) 2025201350913

(51) Int. Cl. G02B 1/14; G02C 7/02

(52) U.S. Cl. CPC G02B 1/14; G02C 7/02

(57) ABSTRACT

An iridescent optical film that includes a first film layer, a second film layer, a third film layer, a fourth film layer, and a fifth film layer laminated with respect to one another in a sequence from top to bottom. Both the first film layer and the fifth film layer are protective films. The second film layer is a triacetyl cellulose reinforced film layer. The third film layer is a liquid crystal iridescent reflective layer. The fourth film layer is a triacetyl cellulose white plain layer, an anti-UV film, a polarizing film, a monochromatic film, or a color-changing film. The fifth film layer may be an electrostatic film.

### TECHNICAL FIELD

The present invention pertains to the technical field of lens production, and particularly relates to an iridescent optical film.

### BACKGROUND OF THE INVENTION

Most of the traditional sunglass lenses employ a method of electroplating a reflective layer on a lens surface to impart a reflective function to the lens surface. An electroplated layer needs to match a curvature of the lens surface, and must undergo baking and bending processes prior to electroplating. Since the electroplated layer is mostly composed of metal materials, cracks can be easily formed on a surface thereof during the baking and bending processes. Therefore, a complete production process flow involves cutting the electroplated layer into small pieces, baking and bending the small pieces respectively, and then electroplating the small pieces one by one. However, such kind of prior art involves high manufacturing costs.

Although a lens has a reflective effect after electroplating, the lens is also susceptible to scratches from hard objects during daily use. For example, when a user wipes the lens with a rough tissue or cloth, the electroplated layer may be scratched, leading to degradation in optical performance of the lens and an impact on clarity of the lens. If the lens is not properly maintained, such as if the lens is frequently exposed to high-temperature environments, or cleaned by corrosive cleaning agents, or being in contact with seaside air and seawater, the electroplated layer may be detached from the lens surface, thereby affecting the intended function of the lens. In addition, existing electroplated lenses also suffer from a drawback of monochromatic coloration.

### BRIEF SUMMARY OF THE INVENTION

A primary object of the present invention is to provide an iridescent optical film that addresses the problems existing in the prior art, avoids complex processing steps during lamination with a lens, and possesses properties such as wear resistance, corrosion resistance, and prevention of detachment.

To attain the above object, the present invention provides the following technical solutions:

An iridescent optical film, comprising a first film layer, a second film layer, a third film layer, a fourth film layer, and a fifth film layer laminated with respect to one another in a sequence from top to bottom; both the first film layer and the fifth film layer are protective films; the second film layer is a triacetyl cellulose (TAC) reinforced film layer; the third film layer is a liquid crystal iridescent reflective layer; the fourth film layer is a TAC white plain layer, an anti-UV film, a polarizing film, a monochromatic film, or a color-changing film.

The first film layer is made of polyvinyl chloride (PVC).

Preferably, the fifth film layer is an electrostatic film.

Preferably, the fifth film layer is made of polyethylene (PE).

A thickness of each of the first film layer and the fifth film layer is 10 to 15 μm.

A thickness of the second film layer is 180 to 200 μm.

A thickness of the third film layer is 2 μm, and a light reflectivity thereof is 8 to 10%.

A thickness of the fourth film layer is 180 to 200 μm.

The technical solutions according to the present invention has the following technical effects:

Through the above technical solutions, the present invention employs existing processes and existing materials to fabricate a film having specific properties such as iridescence, wear-resistance, corrosion-resistance, and possessing a certain degree of flexibility. Compared to traditional electroplated films that require cutting into small pieces, baking and bending of the small pieces, followed by electroplating o the small pieces one by one, the processing technology according to the present invention is simpler, avoiding the complicated steps of electroplating the small pieces one by one and the resulting possible low yield rate; since the third film layer is protected between the second film layer and the fourth film layer, the second film layer and the fourth film layer are utilized to isolate and protect the third film layer, eliminating issues such as scratching, corrosion, and detachment, and providing richer colors, wherein a same base color system can exhibit rich and varied color changes when observed from different angles.

### BRIEF DESCRIPTION OF THE DRAWINGS

FIG. 1 is a schematic diagram of a layered structure according to a specific embodiment of the present invention.

### Reference numerals in the drawings:

1 - first film layer; 2 - second film layer; 3 - third film layer; 4 - fourth film layer; 5 - fifth film layer.

### DETAILED DESCRIPTION OF THE INVENTION

To further explain the technical solutions of the present invention, the present invention is described in detail below with reference to specific embodiments.

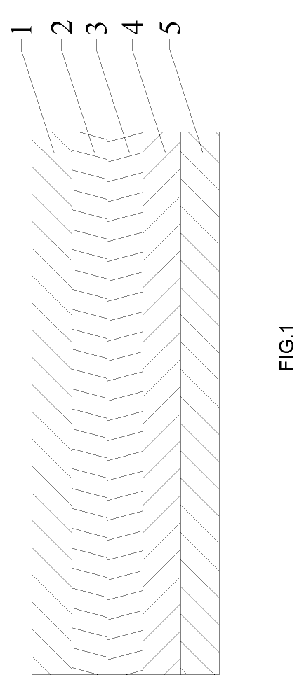

Referring to FIG. 1, the present invention discloses an iridescent optical film, comprising a first film layer 1, a second film layer 2, a third film layer 3, a fourth film layer 4, and a fifth film layer 5 laminated with respect to one another in a sequence from top to bottom;

both the first film layer 1 and the fifth film layer 5 are protective films;

the second film layer 2 is a TAC (triacetyl cellulose) reinforced film layer;

the third film layer 3 is a liquid crystal iridescent reflective layer;

the fourth film layer 4 is a TAC white plain layer, an anti-UV film, a polarizing film, a monochromatic film, or a color-changing film.

Through the above technical solutions, the present invention employs existing processes and existing materials to fabricate a film having specific properties such as iridescence, wear-resistance, corrosion-resistance, and possessing a certain degree of flexibility. Compared to traditional electroplated films that require cutting into small pieces, baking and bending of the small pieces, followed by electroplating o the small pieces one by one, the processing technology according to the present invention is simpler, avoiding the complicated steps of electroplating the small pieces one by one and the resulting possible low yield rate; since the third film layer 3 is protected between the second film layer 2 and the fourth film layer 4, the second film layer 2 and the fourth film layer 4 are utilized to isolate and protect the third film layer 3, eliminating issues such as scratching, corrosion, and detachment, and providing richer colors, wherein a same base color system can exhibit rich and varied color changes when observed from different angles.

Specific embodiments of the present invention are described below.

The first film layer 1 is made of polyvinyl chloride (PVC); the fifth film layer 5 is an electrostatic film, preferably made of polyethylene (PE); and a thickness of each of the first film layer 1 and the fifth film layer 5 is 10 to 15 μm.

The second film layer 2 possesses strong wear resistance and compression resistance, and can serve as an outermost layer of a lens after lamination; a thickness of the second film layer 2 is 180 to 200 μm.

The third film layer 3 has rich colors, can exhibit a variety of changing colors when observed from different angles, and can effectively reflect sunlight, providing a more aesthetically pleasing and stylish appearance; a thickness of the third film layer 3 is 2 μm, and a light reflectivity thereof being 8 to 10%. Specifically: liquid crystal molecules exhibit specific orientation arrangements; when illuminated by light, the liquid crystal molecules with different orientations produce different refraction, reflection, and scattering effects on the light, thereby presenting rich and varied color changes when observed from different angles; the third film layer 3 has a unique visual effect capable of meeting people's demands for personalization and aesthetics; the third film layer 3 has good light transmittance, presenting iridescent effects without significantly obstructing a line of sight, thereby ensuring clear vision while being both aesthetically pleasing and not impairing visual function. Furthermore, the third film layer 3 possesses good physical properties and chemical stability, including good weather resistance, aging resistance, chemical corrosion resistance, and the like, enabling maintenance of stable performance and appearance during long-term use.

The fourth film layer 4 serves as a protective layer for the third film layer 3; after lamination, a resulting product can be further combined with different functional film layers; a thickness of the fourth film layer 4 is 180 to 200 μm.

### A processing process of the present invention is as follows:

(1) covering a hard coating (HC) surface of the second film layer 2 with a protective film, and then performing saponification treatment on another opposite surface thereof;

(2) mixing a liquid crystal material with a specific resin, a solvent, and the like to prepare a liquid crystal coating solution, then using a coating process to uniformly coat the liquid crystal coating solution onto a substrate film such as polyethylene terephthalate (PET), followed by high-temperature drying and UV light curing treatments, such that liquid crystal molecules form specific orientations and arrangements on a surface of the substrate film, thereby obtaining the third film layer 3, which is the liquid crystal iridescent reflective layer;

(3) after laminating the third film layer 3 with the second film layer 2, peeling off the substrate film, and laminating the third film layer 3 with the fourth film layer 4 to obtain a composite film having an iridescent reflective function;

(4) according to different product requirements, peeling off the fifth film layer 5 from a surface of the fourth film layer 4, laminating the composite film obtained in step (3) with different products to obtain a lens roll material having the iridescent reflective function, and finally performing cutting, baking and bending, and shaping according to different lens sizes.

The above embodiments and drawings do not limit a product form and style of the present invention; any appropriate changes or modifications made by those of ordinary skill in the art should be considered as not departing from a patent scope of the present invention.

1. An iridescent optical film, comprising a first film layer, a second film layer, a third film layer, a fourth film layer, and a fifth film layer laminated with respect to one another in a sequence from top to bottom;
both the first film layer and the fifth film layer are protective films;
the second film layer is a triacetyl cellulose (TAC) reinforced film layer;
the third film layer is a liquid crystal iridescent reflective layer;
the fourth film layer is a TAC white plain layer, an anti-UV film, a polarizing film, a monochromatic film, or a color-changing film.

2. The iridescent optical film of claim 1, wherein the first film layer is made of polyvinyl chloride (PVC).

3. The iridescent optical film of claim 2, wherein the fifth film layer is an electrostatic film.

4. The iridescent optical film of claim 3, wherein the fifth film layer is made of polyethylene (PE).

5. The iridescent optical film of claim 1, wherein a thickness of each of the first film layer and the fifth film layer is 10 to 15 μm.

6. The iridescent optical film of claim 1, wherein a thickness of the second film layer is 180 to 200 μm.

7. The iridescent optical film of claim 1, wherein a thickness of the third film layer is 2 μm, and a light reflectivity thereof is 8 to 10%.

8. The iridescent optical film of claim 1, wherein a thickness of the fourth film layer is 180 to 200 μm.
